(19) United States
(12) Patent Application Publication
(10) Pub. No.: US 2017/0067773 A1
(43) Pub. Date: Mar. 9, 2017

(54) SYSTEM AND METHOD OF DETERMINING VALUE OF PHYSICAL ITEMS

(71) Applicant: Ofer Shalom, Sherman Oaks, CA (US)

(72) Inventor: Ofer Shalom, Sherman Oaks, CA (US)

(21) Appl. No.: 15/005,655

(22) Filed: Jan. 25, 2016

Related U.S. Application Data
(60) Provisional application No. 62/283,518, filed on Sep. 4, 2015.

(51) Int. Cl. G01G 19/414; G01G 23/36

(52) U.S. Cl. CPC G01G 19/414; G01G 23/36

(57) ABSTRACT

A system for calculating the value of physical items, comprising: one or more weight devices; and one or more collection devices; wherein said one or more weight devices comprise a pad, one or more plates, one or more transducers, a data transfer module, and a power source; wherein said one or more transducers are configured to determine a weight of one or more objects when said one or more transducers measure a load generated by said one or more objects applying a vertical force onto said one or more transducers, said vertical force is then converted into an electrical impulse proportional to said load, which is then converted into said weight of one or more objects; wherein said data transfer module is configured to transmit a first signal comprising information relating to said weight of said one or more objects.

### CROSS-REFERENCE TO RELATED APPLICATIONS

This Non-Provisional U.S. Patent Application claims the benefit of U.S. Provisional Patent Application No. 62/283,518 filed on Sep. 5, 2015, titled “Universal continuous coin counting machine located at the floor of cash register and weight information transmitted by blue tooth, to analytical program and devices such as cell phone, computer, analytical data collector remotely or on site”, by inventor Ofer Shalom, the contents of which are expressly incorporated herein by this reference.

### FIELD

The present disclosure relates generally to devices for calculating the value of physical currency, and more particularly to devices which are able to calculate physical currency based on weight.

### BACKGROUND

Even in the modern age of wireless, digital, and plastic card payment methods, physical currency is still utilized. However, keeping accurate records of physical currency can be difficult, if not impossible, especially when trying to keep track of physical currency in real time with the daily transactions.

Typically, in order to quickly determine the value of coins present, a user would need to remove all the coins from a receptacle from which the coins were being stored and either count the coins or use a coin counting machine. Either of these methods requires that the user halt any work they were performing, thereby interrupting workflow.

Furthermore, because businesses often have multiple employees who each have their own coin receptacle, the process described above would be even more time consuming as it would need to be repeated for each and every employee. This would also mean that obtaining information on all coin amounts at the same time is a near impossibility.

Additionally, it is sometimes beneficial to keep a running value of the contents of a container, but pausing to do this is undesirable as it would require time and effort of the user. Furthermore, it would be valuable to be able to easily monitor various other objects, whose value could be determined based on weight.

Keeping an accurate record of the physical objects and their value is important because it helps individuals and businesses track income and ensure proper management thereof. However, the existing methods mentioned above are prohibitive to the extent that they are not readily practiced. Additionally, existing methods do not transmit the information generated to any form of usable medium. Thus, in order to utilize the information effectively, a user would need to accurately transcribe the information and transmit the information to a useful medium. This is not practicable.

Current methods of tracking physical currency often utilize outdated technology and have failed to modernize to meet the demand These methods lack interconnectivity, ease of use, and even ability to be used.

U.S. Pat. No. 7,992,768, issued to Benigno (“Benigno”) discloses a device for the measurement of value of coins in change compartments of a cash register tray Importantly, the invention disclosed in Benigno is a rigid invention which must be used with specific cash register designs, rather than various containers of different sizes because the invention of Benigno fits or floats into existing cash register trays. There is no ability to use the invention of Benigno for purposes deviating from the cash register as taught, or for use with other applications such as medication amounts.

Therefore, what is needed is a method for accurately determining the value of physical currency and other objects without disrupting workflow, and transmitting the information to a format that would be more useful. The new value determining system may comprise a device which passively determines the value of a certain amount of currency and transmits the information to a server for processing.

### SUMMARY OF THE INVENTION

To minimize the limitations in the prior art, and to minimize other limitations that will become apparent upon reading and understanding the present specification, the following discloses a new and improved system for monitoring value of objects.

One embodiment may be a system for calculating the value of physical items, comprising one or more weight devices; wherein the one or more weight devices may comprise a pad, one or more plates, one or more transducers, a data transfer module, and a power source; wherein the one or more transducers may be configured to determine a weight of one or more objects by having a load on the one or more transducers generated by the one or more objects applying a vertical force onto the one or more transducers, the vertical force may then converted into an electrical impulse proportional to the load, which may then be converted into the weight of one or more objects; wherein the data transfer module may be configured to transmit a first signal comprising information relating to the weight of the one or more objects. The first signal may be configured to be sent to one or more servers to determine a value of the one or more objects by multiplying the weight of the one or more objects times a known weight-value of the one or more objects. Alternatively, the system for calculating the value of physical items may further comprise one or more collection devices; and the one or more collection devices may be configured to receive the first signal and transmit a second signal to one or more servers to determine a value of the one or more objects by multiplying the weight of the one or more objects times a known weight-value of the one or more objects. The one or more servers may be configured to send alerts to a user's electronic device and the alerts may be configured to be sent to the user's electronic device upon a trigger. The alerts may comprise information related to the value. The one or more plates may be located within the pad and the one or more plates may span a substantial portion of the pad; wherein the one or more plates may be a thin aluminum sheet; and wherein the pad may be non-absorbent. The one or more transducers, the data transfer module, and the power source may be located substantially towards the center of the weight device. The one or more weight devices may be reduced in size while the one or more transducers, the data transfer module, and the power source remain functional; and wherein the one or more weight devices may be configured to be reduced in size by removing portions of the pad and the plate. The data transfer module may comprise a wireless connectivity. The wireless connectivity may be a low power point to point communication protocol. The power source may be a battery, or may be a physical wire connection. The one or more objects may comprise coins, precious metals, jewelry, gemstones, medication, consumables, boxes, and trucks. The one or more weight devices further comprises a display configured to display a value of the one or more objects.

Another embodiment of a system for calculating the value of physical items may comprise one or more weight devices and one or more collection devices; wherein the one or more weight devices may comprise a pad, one or more plates, one or more transducers, a data transfer module, and a power source; wherein the one or more transducers may be configured to determine a weight of one or more objects by having a load on the one or more transducers generated by the one or more objects applying a vertical force onto the one or more transducers, the vertical force is then converted into an electrical impulse proportional to the load, which is then converted into the weight of one or more objects; wherein the data transfer module may be configured to transmit a first signal comprising information relating to the weight of the one or more objects; wherein the one or more collection devices may be configured to receive the first signal and transmit a second signal to one or more servers to determine a value of the one or more objects by multiplying the weight of the one or more objects times a known weight-value of the one or more objects; wherein the one or more servers may be configured to send alerts to a user's electronic device; wherein the alerts may be configured to be sent to the user's electronic device upon a trigger; wherein the alerts may comprise information related to the value; wherein the one or more plates may be located within the pad and the one or more plates may span a substantial portion of the pad; wherein the one or more plates may be a thin aluminum sheet; wherein the pad may be non-absorbent; wherein the one or more transducers, the data transfer module, and the power source may be located substantially towards the center of the weight device; wherein the one or more weight devices may be reduced in size while the one or more transducers, the data transfer module, and the power source remain functional; wherein the one or more weight devices may be configured to be reduced in size by removing portions of the pad and the plate; wherein the data transfer module may comprise a wireless connectivity; wherein the wireless connectivity may be a low power point to point communication protocol; wherein the power source may be a battery; wherein the one or more objects may comprise coins, precious metals, jewelry, gemstones, medication, consumables, boxes, and trucks; and wherein the one or more weight devices may further comprise a display configured to display a value of the one or more objects.

Another embodiment of a system for calculating the value of physical items may comprise one or more weight devices; wherein the one or more weight devices may comprise a pad, one or more plates, one or more transducers, a data transfer module, and a power source; wherein the one or more transducers may be configured to determine a weight of one or more objects by having a load on the one or more transducers generated by the one or more objects applying a vertical force onto the one or more transducers, the vertical force is then converted into an electrical impulse proportional to the load, which is then converted into the weight of one or more objects; wherein the data transfer module may be configured to transmit a first signal comprising information relating to the weight of the one or more objects; wherein the first signal is configured to be sent to one or more servers to determine a value of the one or more objects by multiplying the weight of the one or more objects times a known weight-value of the one or more objects; wherein the one or more servers may be configured to send alerts to a user's electronic device; wherein the alerts may be configured to be sent to the user's electronic device upon a trigger; wherein the alerts may comprise information related to the value; wherein the one or more plates may be located within the pad and the one or more plates may span a substantial portion of the pad; wherein the one or more plates may be a thin aluminum sheet; wherein the pad may be non-absorbent; wherein the one or more transducers, the data transfer module, and the power source may be located substantially towards the center of the weight device; wherein the one or more weight devices may be reduced in size while the one or more transducers, the data transfer module, and the power source remain functional; wherein the one or more weight devices may be configured to be reduced in size by removing portions of the pad and the plate; wherein the data transfer module may comprise a wireless connectivity; wherein the wireless connectivity may be a low power point to point communication protocol; wherein the power source may be a battery; wherein the one or more objects may comprise coins, precious metals, jewelry, gemstones, medication, consumables, boxes, and trucks; and wherein the one or more weight devices may further comprise a display configured to display a value of the one or more objects.

Further objects and advantages will become apparent from a consideration of the ensuing description and drawings.

These and other objectives, features, and advantages will become apparent from the following detailed description, accompanying drawings, and appended claims.

Additional embodiments of the invention will be understood from the detailed description of the invention.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is an illustration of one embodiment of the weight device.

FIG. 2 is a cross-sectional illustration of one embodiment of the weight device showing the weight devices internal components.

FIG. 3 is a flow chart of one embodiment of the system of determining value of physical items.

FIG. 4 is a block diagram of one embodiment of the system of determining value of physical items.

FIG. 5 is a block diagram of one embodiment of the system of determining value of physical items.

FIG. 6 is a flow chart of one embodiment of the system of determining value of physical items utilizing a collection device.

FIG. 7 is a block diagram of one embodiment of the system of determining value of physical items utilizing a collection device.

FIG. 8 is a block diagram of one embodiment of the system of determining value of physical items utilizing a collection device.

### DETAILED DESCRIPTION OF THE ILLUSTRATIVE EMBODIMENTS

In the following detailed description of various embodiments, numerous specific details are set forth in order to provide a thorough understanding of various aspects of one or more embodiments. However, one or more embodiments may be practiced without some or all of these specific details. In other instances, well-known methods, procedures, and/or components have not been described in detail so as not to unnecessarily obscure aspects of the embodiments.

While multiple embodiments are disclosed, still others will become apparent to those skilled in the art from the following detailed description, which shows and describes illustrative embodiments. As will be realized, the various embodiments are capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment shall not be interpreted to limit the scope of the disclosure.

Before the illustrative embodiments are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

### Definitions

In the following description, certain terminology is used to describe certain features of one or more embodiments. For example, as used herein, the terms “computer”, “mobile computing device”, “external electronic device”, and “electronic data processing unit” generally refer to any device that processes information with an integrated circuit chip, including without limitation, mainframe computers, work stations, gaming consoles, servers, desktop computers, portable computers, laptop computers, and embedded computers. Furthermore, the terms “mobile computing device” and “external electronic device” may refer to any devices with wireless capabilities, including without limitation, cellular phones, tablet computers, personal digital assistants, digital media players, portable game players, and hand-held computers.

As used herein, the term “Internet” may refer to any collection of networks that utilizes standard protocols, whether Ethernet, Token ring, WiFi®, asynchronous transfer mode (ATM), Fiber Distributed Data Interface (FDDI), code division multiple access (CDMA), global systems for mobile communications (GSM), long term evolution (LTE), or any combination thereof.

As used herein, the terms “display” and “display screen” generally refer to any electronic output device for the visual presentation of digital content. The displays disclosed herein may utilize various screen technologies, including without limitation, liquid crystal display (LCD), light emitting diode (LED), thin-film transistor (TFT), and the like.

As used herein, the terms “application”, “software”, and “software application” generally refer to any set of machine-readable instructions on a client machine, web interface, and/or computer, downloadable or externally hosted, which directs a computer's processor to perform specific steps, processes, or operations disclosed herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary.

The present specification discloses a system and method for determining value of physical items in real-time. The system and method may comprise one or more weight devices and one or more servers. The system and method may additionally comprise one or more collection devices.

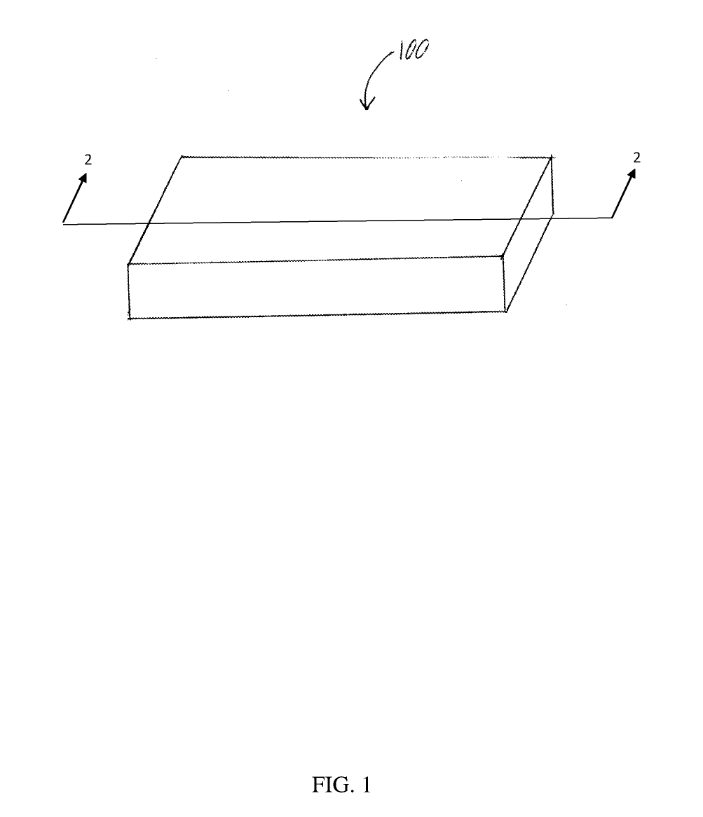

FIG. 1 is an illustration of one embodiment of the weight device. As shown in FIG. 1, one embodiment of the weight device 100 may be substantially rectangular. In additional embodiments, rather than being rectangular, the weight device 100 may be constructed of any shape, including rectangles, squares, circles, trapezoids, irregular shapes, and the like. Furthermore, should the weight device 100 be in an undesirable shape, a user may adjust the size and shape of the weight device by removing excess material (e.g., trimming) The weight device 100 may comprise various internal components, including a plate, a battery, a transducer, and a wireless module. In a preferred embodiment, the weight device 100 may be thin, such that it may be placed inside a small container. In one embodiment, the weight device 100 may be less than 5 mm thick. Preferably, the weight device is thin enough, such that it may be used to line the bottom of various containers, including medicine and pill containers without occupying a significant amount of interior space within the container.

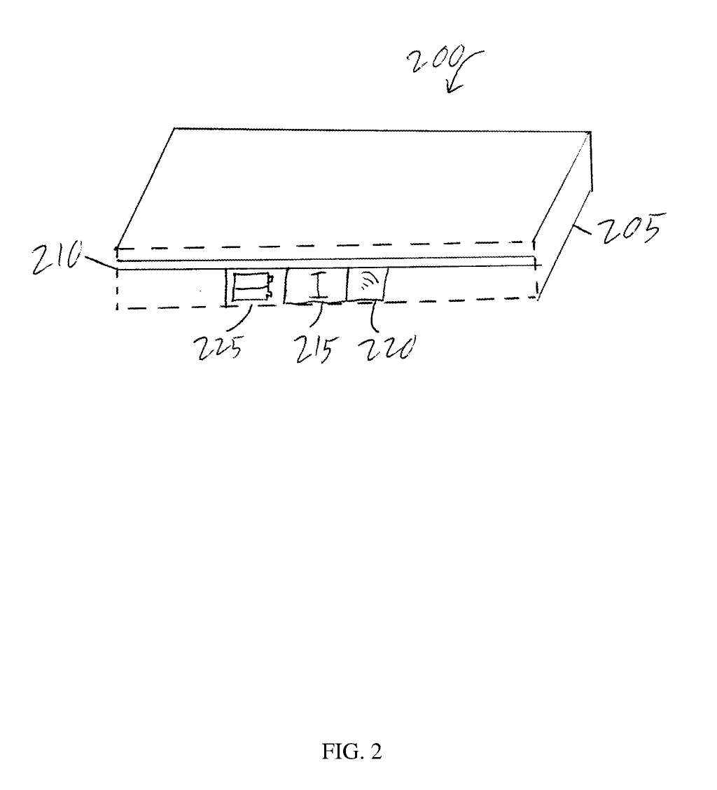

FIG. 2 is a cross-sectional illustration of one embodiment of the weight device showing the weight devices internal components. As shown in FIG. 2, one embodiment of the weight device 200 may comprise: a pad 205, a plate 210, a transducer 215, a wireless module 220, and a battery 225. The pad 205 may be a non-absorbent material, such as rubber or silicone with some degree of flexibility. The plate 210 may be a rigid material, such as aluminum, hard plastic, or other material with rigidity. The transducer 215 may be a device capable of measuring the force applied onto it to determine the weight of one or more objects which apply the force. The wireless module 220 may be a device configured to transmit a wireless signal via a low power point to point communication protocol, such as WiFi® or Bluetooth®.

In one embodiment, the plate 210 may span a substantial portion of the pad 205, such that the plate 210 provides the relatively less rigid pad 205 with a semi-rigid or rigid internal structure. In this embodiment, the plate 210 may also be located substantially below the upper surface of the pad 210 and above the transducer 215, the wireless module 220, and the battery 225.

The transducer 215 may be configured to determine a load by measuring a downward force caused by the placement of one or more objects onto the pad 205. Even though the pad 205 may have some degree of flexibility, the plate 210 preferably provides an amount of rigidity. This ensures that when the objects are placed on the pad 205, the weight of the objects may be applied throughout the pad 205 to the plate 210 and then to the transducer 215 (rather than having the weight of the objects as measured by the transducer 215 be inaccurate). This is because the weight of the objects may cause the pad 205 to bend and make contact with another object.

The wireless module 220 may transmit information generated by the transducer 215 to one or more devices, such as one or more servers and/or one or more collection devices. The information may be transmitted wirelessly via a low power point to point communication protocol, such as Bluetooth®, WiFi®, Internet, or any other wireless connectivity protocol. If the information is transmitted to the collection devices, the collection devices may then send the information to the servers.

The one or more batteries 225 may act as a power source for the transducer 215 and the wireless module 220, or any other electronics that another embodiment of the invention may comprise.

The plate 210 may be thin such that a user would be capable of cutting through both the plate 210 and the pad 205 with scissors or shears. Additionally, the transducer 215, wireless module 220, and one or more batteries 225 may be located substantially within the center of the pad 205 and/or along the bottom portion of the pad 205. This preferably allows a user to reduce the footprint of the weight device by simply cutting through the pad 205 and plate 210. The footprint, as disclosed herein, refers to the amount of surface space an item occupies, or the width and depth of the item, not including the height. One benefit of this configuration is that a single size weight device may be marketed and sold, and then customized to fit a desired size of the weight device for virtually any situation or container.

A user may utilize the weight device 200 to measure the weight of one or more objects, such as coins, paper currency, precious metals, and medication. Once the weight is determined, the weight device 200 may be used to transmit the weight information to one or more servers.

In an alternate embodiment, the weight device 200 may further comprise a display, which may show to a user observing the weight device 200, the weight of the objects on the weight device 200.

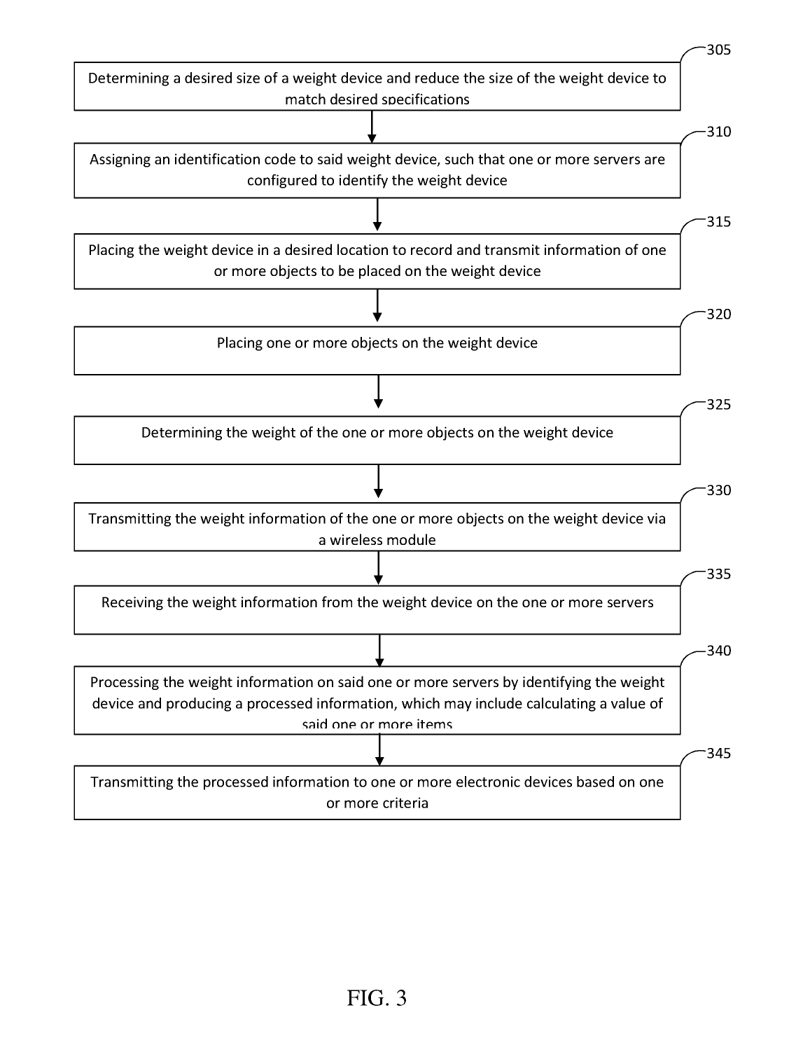

FIG. 3 is a flow chart of one embodiment of the system of determining value of physical items. As shown in FIG. 3, one embodiment of the system of determining value of physical items may comprise the steps: determining a desired size of a weight device and reduce the size of the weight device to match desired specifications 305; assigning an identification code to said weight device, such that one or more servers are configured to identify the weight device 310; placing the weight device in a desired location to record and transmit information of one or more objects to be placed on the weight device 315; placing one or more objects on the weight device 320; determining the weight of the one or more objects on the weight device 325; transmitting the weight information of the one or more objects on the weight device via a wireless module 330; receiving the weight information on the one or more servers 335; processing the weight information on said one or more servers by identifying the weight device and producing a processed information, which may include calculating a value of said one or more items 340; and transmitting the processed information to one or more electronic devices based on one or more criteria 345.

Determining a desired size of a weight device and reducing the size of the weight device to match desired specifications 305 may be performed by a user selecting a location which the user wishes to monitor for the value of physical objects resting at the location. For example, if the user desires to monitor a compartment, the user may cut or trim the weight device such that the weight device may lay flat along the bottom of the compartment.

Assigning an identification code to said weight device, such that one or more servers are configured to identify the weight device 310 may be performed by allowing the servers to keep track of where a weight device is located. This may require the weight device to be in communication with the server(s) in order to properly configure the weight device and server(s). Once the server(s) have assigned an identification code, a user may instruct the server(s) as to what is likely to be placed on top of the weight device for information processing purposes.

Placing the weight device in a desired location to record and transmit information of one or more objects to be placed on the weight device 315 may be accomplished simply by moving the weight device to a location for which the weight device may have been reduced in size to fit.

Placing one or more objects on the weight device 320 may be achieved by placing an object, such as a coin, precious metal, or other item with a calculatable value, on the weight device.

Determining the weight of the one or more objects on the weight device 325 may be performed by the transducer built into the weight device. The transducer may be configured to measure an amount of downward force, and therefore determine the weight of the one or more objects on the weight device.

Transmitting the weight information of the one or more objects on the weight device via a wireless module 330 may allow information collected by the weight device to be sent to the server(s), which then may receive the weight information on the servers 335.

Processing the weight information on said one or more servers by identifying the weight device and producing a processed information, which may include calculating a value of said one or more items 340 may be performed by analyzing the weight of the one or more objects against a known value per unit of weight of the one or more objects. For example, where the weight device is placed in a receptacle that only receives dimes, the server(s) may use the known value of a dime per unit weight and multiply that value by the weight contained in the weight information.

The next step is transmitting the processed information to one or more electronic devices based on one or more criteria 345. The information, once processed by the server(s), may then transmit information to other electronic devices. This may be done through wired or wireless signals.

All the signals described above and below may be transmitted based on various criteria. In one embodiment, the various criteria may be described as trigger events. The trigger events may comprise events such as a change in time, change in weight, change in value, or any other event which may be determined by the user of the system of determining value of physical items or provider of the system of determining value of physical items. This may allow a user to create a personalized system of determining value of physical items which sends signals when it is most beneficial to have that information for that user.

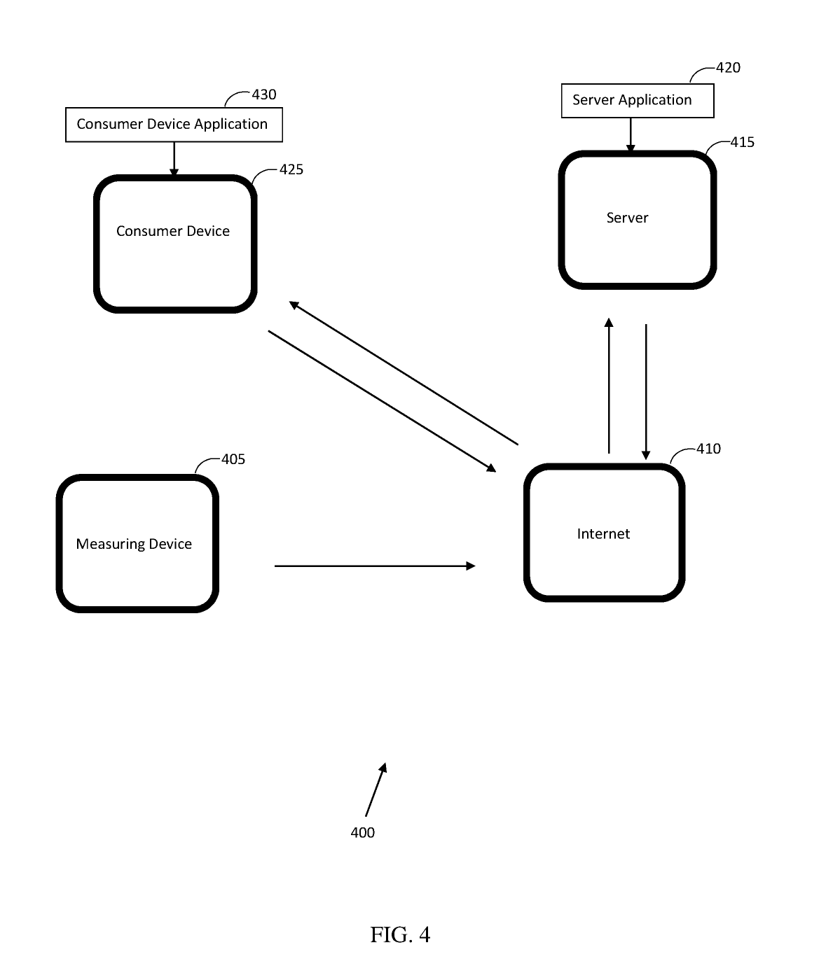

FIG. 4 is a block diagram of one embodiment of the system of determining value of physical items. As shown in FIG. 4, one embodiment of the system of determining value of physical items 400 may comprise: a measuring device 405; Internet 410; a server 415; a server application 420; a consumer device 425; and a consumer device application 430. The measuring device 405 may be substantially similar to the weight device 200 shown in FIG. 2. The measuring device 405 may be configured to transmit a WiFi® signal comprising information related to the weight of an item on the measuring device 405 through the Internet 410 to a server 415. The Internet 410 may be a computer network consisting of a worldwide network of computers that use TCP/IP network protocols to facilitate data transmission and exchange.

Once the server 415 receives the information related to the weight of the item on the measuring device 405, the server application 420 may process the information to generate a value corresponding to the item on the measuring device 405. For example, if the item(s) on the measuring device 405 weigh 10 grams, and 1 gram of the item would be equivalent to one dollar, then the server application 420 would process the 10 gram information and convert and provide an output stating the value of the item(s) on the measuring device 405 is ten dollars. The server application 420 may utilize pre-determined algorithms to determine the value. For example, where a user knows a certain measuring device 405 is used as a receptacle for coins having a value of one dollar per gram, the server application 420 may be configured to generate a value of the total amount of coins in the receptacle based on weight information sent by the measuring device 405. The weight information may be sent with a means for identifying from which measuring device 405 the weight information was sent, such as including a measuring device 405 identification code or number.

The server 415 may then transmit information through the Internet 410 to a consumer device 425. The consumer device 425 may be a cellular phone, laptop, computer, or any electronic data processing unit capable of receiving signals through the internet. The information transmitted to the consumer device 425 may be information related to the value of items on the measuring device 405. Information may be transmitted to the consumer device 425 at regular intervals, predetermined times, based on changes in the weight of the items on the measuring device 405, or at any other trigger event. Once the information has been received by the consumer device 425, then the consumer device application 430 may process the information into a user friendly configuration, such that the user may be informed of the weight and/or value of items on the measuring device 405. One advantage of this system is that a user may monitor the status and value of objects on the measuring device 405 while physically separated from the measuring device 405. This may be advantageous in automating the addition or removal of items, such as coins, to ensure smooth operation of business.

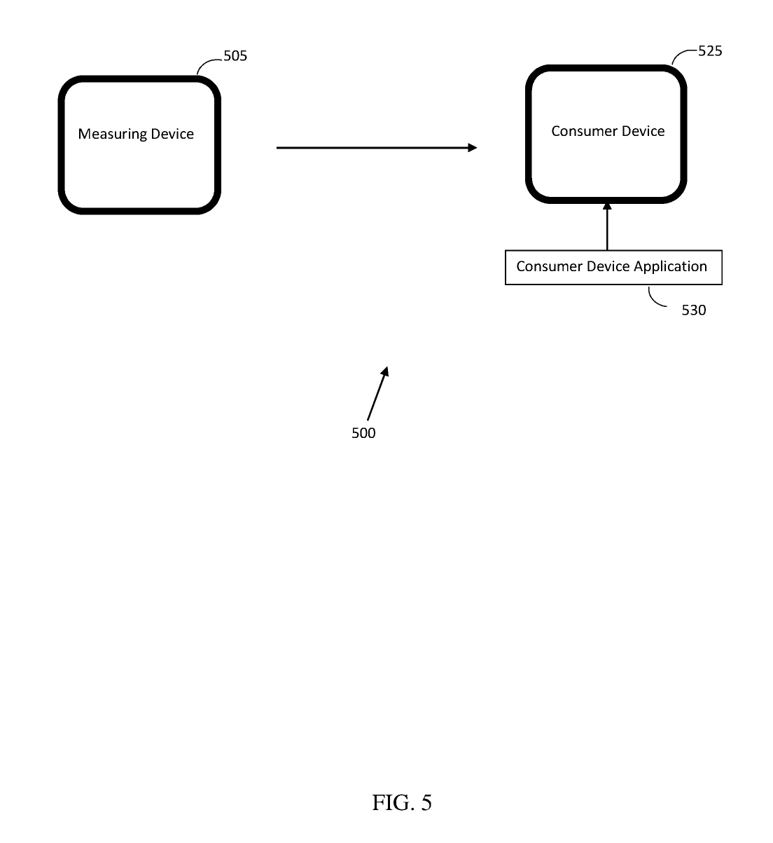

FIG. 5 is a block diagram of one embodiment of the system of determining value of physical items. As shown in FIG. 5, one embodiment of the system of determining value of physical items 500 may comprise: a measuring device 505; a consumer device 525; and a consumer device application 530. The measuring device 505 may be substantially similar to the weight device 200 shown in FIG. 2. The measuring device 505 may be configured to transmit a via a low power point to point communication protocol signal, or Bluetooth® signal, comprising information related to the weight of an item on the measuring device 505 to a consumer device 525.

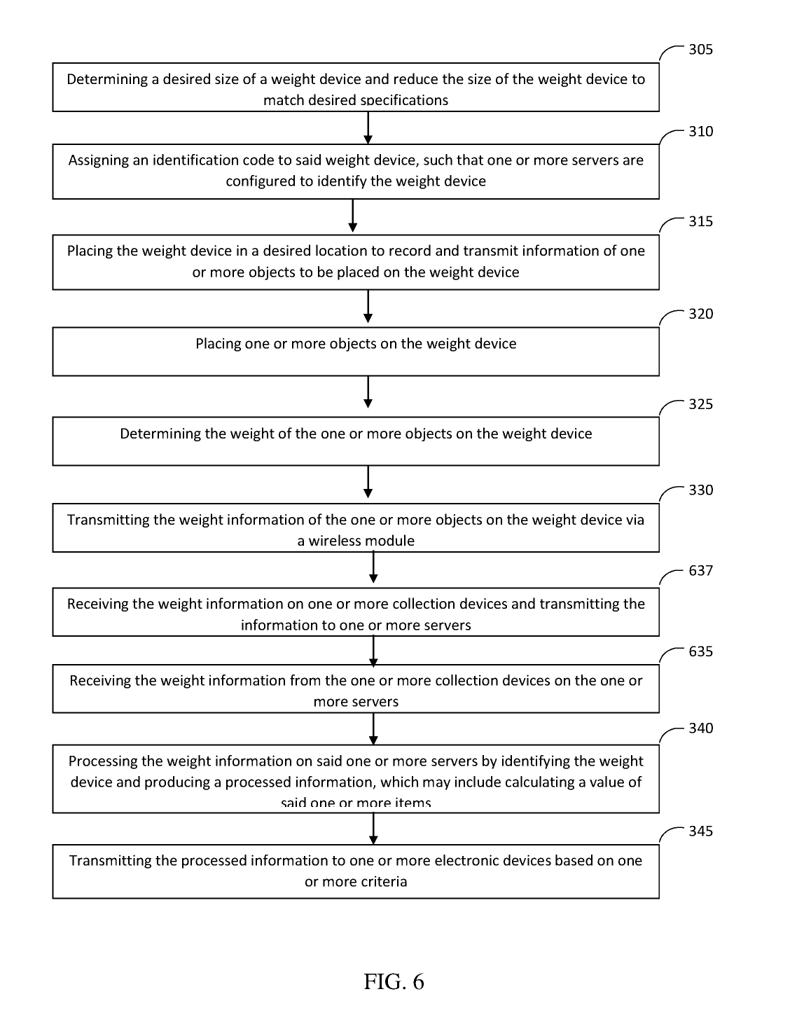

FIG. 6 is a flow chart of one embodiment of the system of determining value of physical items utilizing a collection device. The flow chart depicted in FIG. 6 is similar to the flow chart in FIG. 3, with differences described as follows. The flow chart of FIG. 3 shows that transmitting the weight information of the one or more objects on the weight device via a wireless module 330 is immediately followed by: receiving the weight information on the one or more servers 335, whereas, the embodiment shown and described in FIG. 6 provides that after the weight information is transmitted by the weight device via a wireless module 330, that the information may be received on one or more collection devices, which then in turn transmit the information 637 which is received on the one or more servers 635. Some benefits of the embodiment depicted in FIG. 6 are that where multiple containers or areas need to have weight monitored for changes in value, each of these containers or areas only needs a single weight device which may be configured to send information to a single collection device. This collection device may in turn transmit signals over the Internet, and the collection device thereby acts as a hub, collecting various signals.

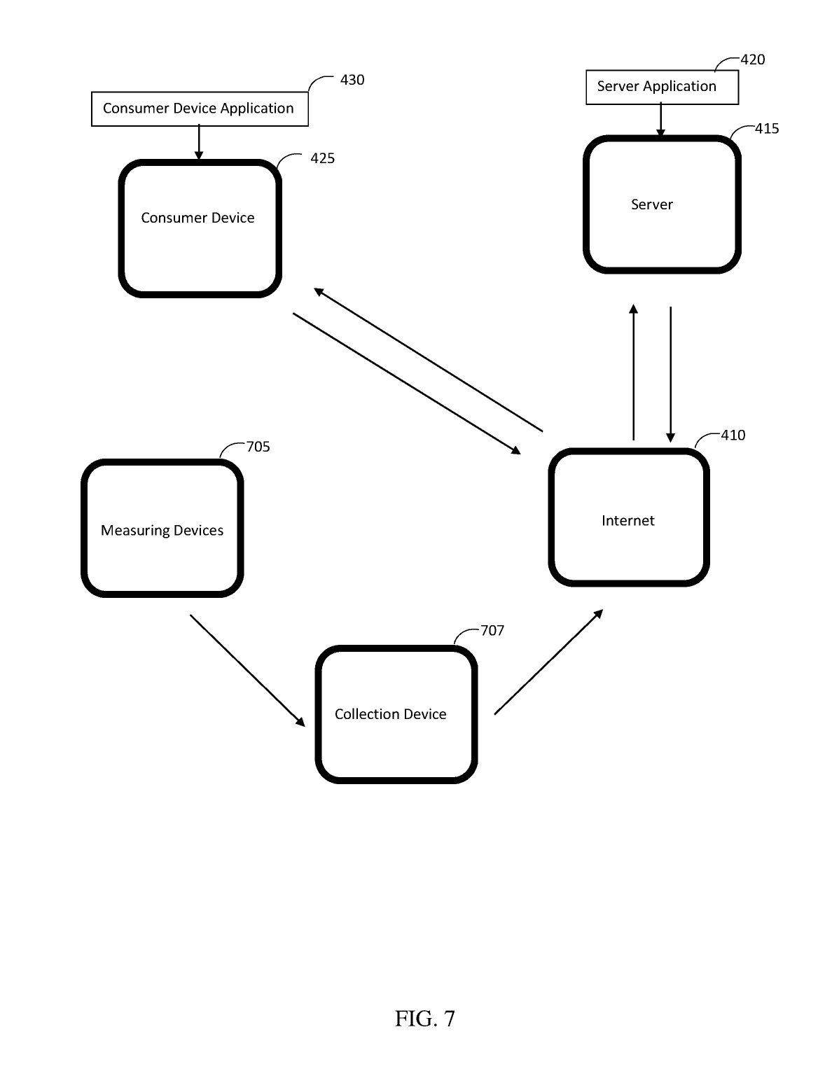

FIG. 7 is a block diagram of one embodiment of the system of determining value of physical items utilizing a collection device. Unlike the embodiment depicted in FIG. 4, the embodiment shown in FIG. 7 comprises one or more measuring devices 705 and a collection device 707, rather than a measuring device 705. Each individual measuring device of the one or more measuring devices 705 may be similar to the measuring device shown in FIG. 1 and FIG. 2. The measuring devices 705 may be configured to transmit a wireless signal which may be received by the collection device 707. This allows a plurality of measuring devices 705 to transmit signals to a single localized location, rather than having each of the measuring devices 705 being Internet capable. Once the signal(s) sent by the measuring devices 705 is received by the collection device 707, the collection device 707 may transmit another signal via the Internet 410 to a server 415, where the signal is then processed as explained in FIG. 4. The collection device may be configured to connect to the internet 410 with wires or without wires.

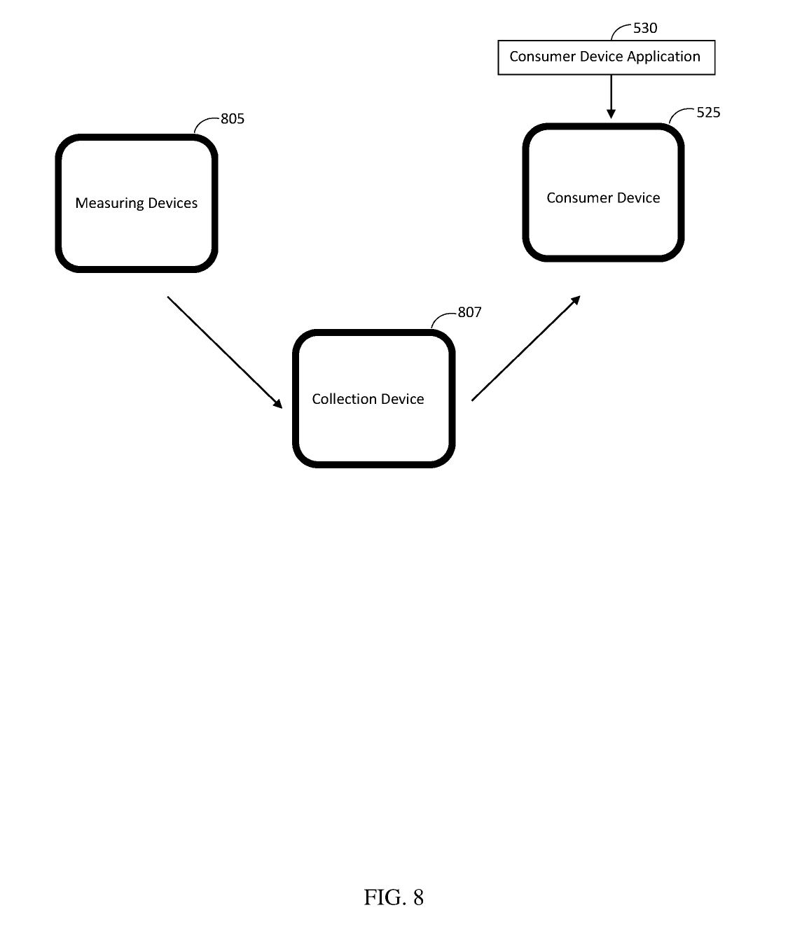

FIG. 8 is a block diagram of one embodiment of the system of determining value of physical items utilizing a collection device. The embodiment shown in FIG. 8 is similar to the embodiment shown in FIG. 5 with the differences being that one or more measuring devices 805 may transmit signals comprising weight information to a collection device 807. The collection device is then preferably capable of sending the consolidated information from the measuring devices to the consumer device 525.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent to the public, regardless of whether it is or is not recited in the claims.

What is claimed is:

1. A system for calculating the value of physical items, comprising:
one or more weight devices;
wherein said one or more weight devices comprise a pad, one or more plates, one or more transducers, a data transfer module, and a power source;
wherein said one or more transducers are configured to determine a weight of one or more objects when said one or more transducers measure a load generated by said one or more objects applying a vertical force onto said one or more transducers;
wherein said vertical force is then converted into an electrical impulse proportional to said load, which is then converted into said weight of one or more objects; and
wherein said data transfer module is configured to transmit a first signal comprising information relating to said weight of said one or more objects.

2. The system for calculating the value of physical items recited in claim 1, wherein said first signal is transmitted to one or more servers to determine a value of said one or more objects by multiplying said weight of said one or more objects with a known weight-value of said one or more objects.

3. The system for calculating the value of physical items recited in claim 1, further comprising: one or more collection devices;
wherein said one or more collection devices are configured to receive said first signal and transmit a second signal to said one or more servers to determine a value of said one or more objects by multiplying said weight of said one or more objects times a known weight-value of said one or more objects.

4. The system for calculating the value of physical items recited in claim 3, wherein said one or more servers are configured to send one or more alerts to an electronic device of a user; and
wherein said one or more alerts are configured to be sent to said electronic device upon a trigger.

5. The system for calculating the value of physical items recited in claim 3, wherein said one or more alerts comprise information related to said value.

6. The system for calculating the value of physical items recited in claim 1, wherein said one or more plates are disposed within said pad and span a substantial portion of said pad;
wherein said one or more plates are a thin aluminum sheet; and
wherein said pad is non-absorbent.

7. The system for calculating the value of physical items recited in claim 6, wherein said one or more transducers, said data transfer module, and said power source are positioned substantially within a center of said weight device.

8. The system for calculating the value of physical items recited in claim 7, wherein said one or more weight devices are configured to be reduced in size while said one or more transducers, said data transfer module, and said power source remain functional; and
wherein said size reduction of said one or more weight devices is performed by removing portions of said pad and said plate.

9. The system for calculating the value of physical items recited in claim 1, wherein said data transfer module comprises a wireless connectivity.

10. The system for calculating the value of physical items recited in claim 9, wherein said wireless connectivity is a low power point to point communication protocol

11. The system for calculating the value of physical items recited in claim 1, wherein said power source is a battery.

12. The system for calculating the value of physical items recited in claim 1, wherein said power source is a physical wire connection.

13. The system for calculating the value of physical items recited in claim 1, wherein said one or more objects comprise coins, precious metals, jewelry, gemstones, medication, consumables, boxes, and trucks.

14. The system for calculating the value of physical items recited in claim 1, wherein said one or more weight devices further comprises a display configured to illustrate a value of said one or more objects.

15. A system for calculating the value of physical items, comprising:
one or more weight devices; and
one or more collection devices;
wherein said one or more weight devices comprise a pad, one or more plates, one or more transducers, a data transfer module, and a power source;
wherein said one or more transducers are configured to determine a weight of one or more objects when said one or more transducers measure a load generated by said one or more objects applying a vertical force onto said one or more transducers;
wherein said vertical force is then converted into an electrical impulse proportional to said load, which is then converted into said weight of one or more objects;
wherein said data transfer module is configured to transmit a first signal comprising information relating to said weight of said one or more objects;
wherein said one or more collection devices are configured to receive said first signal and transmit a second signal to one or more servers to determine a value of said one or more objects by multiplying said weight of said one or more objects with a known weight-value of said one or more objects;
wherein said one or more servers are configured to send alerts to an electronic device of a user;
wherein said alerts are configured to be sent to said electronic device upon a trigger;
wherein said alerts comprise information related to said value;
wherein said one or more plates are disposed within said pad and span a substantial portion of said pad;
wherein said one or more plates are a thin aluminum sheet;
wherein said pad is non-absorbent;
wherein said one or more transducers, said data transfer module, and said power source are located substantially within a center of said weight device;
wherein said one or more weight devices is configured to be reduced in size while said one or more transducers, said data transfer module, and said power source remain functional;
wherein said size reduction of said one or more weight devices is performed by removing portions of said pad and said plate;
wherein said data transfer module comprises a wireless connectivity;
wherein said wireless connectivity is a low power point to point communication protocol;
wherein said power source is a battery;
wherein said one or more objects comprise coins, precious metals, jewelry, gemstones, medication, consumables, boxes, and trucks; and
wherein said one or more weight devices further comprises a display configured to display a value of said one or more objects.

16. A system for calculating the value of physical items, comprising:
one or more weight devices;
wherein said one or more weight devices comprise a pad, one or more plates, one or more transducers, a data transfer module, and a power source;
wherein said one or more transducers are configured to determine a weight of one or more objects when said one or more transducers measure a load generated by said one or more objects applying a vertical force onto said one or more transducers;
wherein said vertical force is then converted into an electrical impulse proportional to said load, which is then converted into said weight of one or more objects;
wherein said data transfer module is configured to transmit a first signal comprising information relating to said weight of said one or more objects;
wherein said first signal is configured to be sent to one or more servers to determine a value of said one or more objects by multiplying said weight of said one or more objects with a known weight-value of said one or more objects;
wherein said one or more servers are configured to send alerts to an electronic device of a user;
wherein said alerts are configured to be sent to said electronic device upon a trigger;
wherein said alerts comprise information related to said value;
wherein said one or more plates are disposed within said pad and span a substantial portion of said pad;
wherein said one or more plates are a thin aluminum sheet;
wherein said pad is non-absorbent;
wherein said one or more transducers, said data transfer module, and said power source are located substantially within a center of said weight device;
wherein said one or more weight devices is configured to be reduced in size while said one or more transducers, said data transfer module, and said power source remain functional;
wherein said size reduction of said one or more weight devices is performed by removing portions of said pad and said plate;
wherein said data transfer module comprises a wireless connectivity;
wherein said wireless connectivity is a low power point to point communication protocol;
wherein said power source is a battery;
wherein said one or more objects comprise coins, precious metals, jewelry, gemstones, medication, consumables, boxes, and trucks; and
wherein said one or more weight devices further comprises a display configured to display a value of said one or more objects.
